(19) United States
(12) Patent Application Publication
(10) Pub. No.: US 2026/0082101 A1
(43) Pub. Date: Mar. 19, 2026

(54) Wireless Multi-Casting With Virtual Reality Devices

(71) Applicant: Inspirit Learning, Inc., Atlanta, GA (US)

(72) Inventors: Abhilash Gopal, Bangalore (IN); Mohammed Umer, Bengaluru (IN); Rahul Singh, Bengaluru (IN); Akash Deep, Bengaluru (IN)

(21) Appl. No.: 19/323,283

(22) Filed: Sep. 9, 2025

(30) Foreign Application Priority Data
Sep. 13, 2024 (IN) 202441069348

(51) Int. Cl. H04N 21/44; G02B 27/01; H04L 67/02; H04N 21/433

(52) U.S. Cl. CPC H04N 21/44004; G02B 27/017; H04L 67/02; H04N 21/433

(57) ABSTRACT

A system may include a video encoder configured to receive and encode a video stream of content for display to a user of the virtual reality headset. The system may include a video buffer configured to store the encoded video stream for rendering and transmission. The system may include a WebSocket server coupled to the video buffer and configured to: establish and maintain independent, full-duplex, and wireless communication connections with a plurality of receiving client computing devices; and stream the encoded video stream stored in the video buffer concurrently to the plurality of receiving client computing devices via the communication connections.

### CROSS REFERENCE TO RELATED APPLICATIONS

This application claims the benefit of and priority to India Patent Application No. 202441069348, filed on Sep. 13, 2024, and titled “Wireless Multi-Casting With Virtual Reality Devices,” which is incorporated herein by reference in its entirety.

### TECHNICAL FIELD

This disclosure generally relates to the field of virtual reality (VR), and more particularly, to casting in a virtual (or augmented) reality environment.

### BACKGROUND

In the context of virtual reality (VR), “casting” refers to the ability to stream or mirror the visual and sometimes auditory experiences from a virtual reality headset to an external display, such as a TV, monitor, or laptop. This feature allows people who are not wearing the headset to see what the user is experiencing in the virtual environment.

Casting, however, has downsides. For example, it may cause privacy and security issues. There may be unintentional exposure to private or sensitive information seen in virtual reality. There may be intrusion risk in which unauthorized users could potentially access and view the casted stream if not properly secured. Casting also may cause interactivity loss such as interactive elements or third-person involvement having synchronization issues. Casting also suffers from complex setup environments. Setting up casting can be technically challenging, requiring proper network settings and compatible casting devices. Further, not all devices or virtual reality platforms support casting, creating limitations based on available hardware and software versions. Moreover, currently available solutions such as CHROMECAST and PICO are limited to being a 1:1 solution, where only one virtual reality headset streams to one device, e.g., laptop or desktop computer.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a diagram illustrating a conventional casting environment.

FIG. 2A is a block diagram illustrating a casting configuration in accordance with an embodiment.

FIG. 2B is a flowchart illustrating a processing flow on a virtual reality headset in accordance with an embodiment.

FIG. 3 is a block diagram illustrating an example virtual reality headset with a stream enabler in accordance with an embodiment.

FIG. 4 is a block diagram illustrating a local area network implementation for stream enabling in accordance with an embodiment.

FIG. 5 is a block diagram illustrating an example of a cloud mode implementation for stream enabling in accordance with an embodiment.

FIG. 6 is an interaction diagram illustrating a WebSocket process flow to stream full duplex mode in accordance with an embodiment.

FIGS. 7A and 7B are charts illustrating examples of video and audio throughput.

FIG. 8 is a flowchart of an example method for casting or streaming, in accordance with an embodiment.

FIG. 9 is a block diagram of an example computing system in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Some embodiments relate to a wireless, offline-capable, multi-streaming system for virtual reality headsets. The system supports both online streaming over the internet and offline streaming over a local area network (LAN). Among other advantages, this system may enable real-time video and audio casting to multiple computing devices over a WebSocket-based transport protocol without proprietary casting application programming interfaces (APIs), universal serial bus (USB) tethering, external high definition multimedia interface (HDMI) capture hardware, or third-party companion applications.

In an offline mode, the system may include a stream enabler hosted on the virtual reality device that establishes a WebSocket server capable of streaming encoded video content (e.g., H.264, H.265) to any authorized client computing device within the same LAN environment. This mode of operation is beneficial in environments where internet connectivity is limited, restricted, or undesired (e.g., enterprise labs, defense installations, educational classrooms, etc.). This allows for peer-to-peer (P2P) streaming with reduced latency and minimized dependency on external infrastructure or cloud services. The system enables multiple virtual reality headsets to simultaneously stream to one or more local devices, including web browsers or native applications, thereby supporting a many-to-many topology.

The stream enabler may also be capable of connecting to cloud-based platforms (e.g., YouTube Live, Twitch, or proprietary cloud infrastructure) to deliver real-time video streams to remote viewers. The system may utilize modern video encoding standards (e.g., H.264 or H.265) and web-compliant protocols (e.g., WebSockets, real time messaging protocol (RTMP)) to support high-quality, low-latency streaming over wide area networks (WANs). By streaming directly from the virtual reality device to a cloud endpoint, the system removes the need for intermediate computing hardware (e.g., tethered PCs or proprietary adapters), thereby reducing setup complexity. This architecture facilitates remote participation, enabling virtual demonstrations, training sessions, or live broadcasting of immersive content to global audiences. The cloud integration allows for stream archiving and retrieval in accordance with organizational or compliance needs.

Regardless of the streaming mode (online or offline), the system may utilize a consistent, protocol-agnostic implementation based on WebSocket communication and video encoding. This reduces fragmentation in deployment and enhances compatibility with various client environments (desktop, mobile, web).

Even if the WebSocket does not include adaptive streaming capabilities, the system may enable adaptive streaming for online situations. For example, the virtual reality headset streams to a cloud server or service that supports adaptive streaming protocols. Client computing devices can then download the video using adaptive streaming protocols.

For streaming over a local area network, the network bandwidth limitation is not an issue as the headset user will likely remain within the coverage area of the local area network while using the headset (since virtual reality experiences are typically limited to a single room or space).

Further, the system may enable stream capture though a client-side application or a web browser implementation. This may be a native application that can be used to stream the virtual reality content wirelessly in the same network or via cloud.

Although descriptions herein are in the context of a virtual reality headset, embodiments are applicable to, and may be implemented by, other types of devices with displays, for example, mixed reality headsets, augmented reality headsets, smart displays, personal computers, and handheld computing devices (e.g., tablet computers) and smartphones. For ease of discussion, client computing devices may also be referred to as computing devices or client devices.

Other aspects include components, devices, systems, improvements, methods, processes, applications, computer readable mediums, and other technologies related to any of the above.

### Introduction

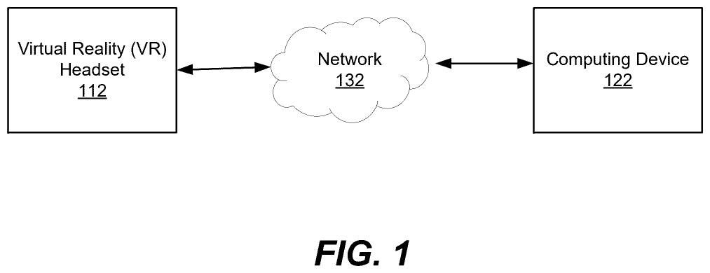

FIG. 1 is a block diagram illustrating a conventional casting environment. The conventional casting environment includes a virtual reality headset 112, a computing device 122 (e.g., a laptop or desktop with monitor), and a network 132. The headset 112 and the computing device 122 may be communicatively coupled through the network 132. The network 132 may be a local area network or may be a wide area network, e.g., the Internet and/or an organizational intranet.

There are many benefits to casting in terms of virtual reality (VR) headsets (or augmented reality headsets. For example, casting may help enhance audience engagement. Casting is particularly useful for sharing the virtual reality experience with others, such as friends, family, or an audience, providing them with a visual representation of the user's experience in real-time. Casting also may be helpful for user support environments. It can be helpful in situations where someone is guiding the virtual reality user, either for instructional purposes, gameplay assistance, or troubleshooting. Casting may be useful for presentation and demonstration. For educators, presenters, or developers, casting may be a valuable tool to showcase virtual reality applications, tools, or games to a larger audience during demonstrations or seminars. Casting also may be beneficial for social interactions. It enhances social interaction by allowing people outside of the virtual reality environment to be part of the experience, fostering shared gaming sessions or collaborative virtual activities.

However, conventional casting has challenges. For example, while it is easy to enable casting from one virtual reality device to one other device, multi-casting from multiple virtual reality devices to one device is not available. Moreover, even with conventional single casting, there is a need for proprietary software in the virtual reality devices or companion apps or specific hardware like Chromecast for streaming. Further, there is an issue of compatibility. The compatibility and methods of casting can vary between different virtual reality headsets and platforms making interoperability challenging.

Furthermore, conventional casting configurations have limitations that include privacy and security, interactivity loss, device limitations, and complex set up. For example, with respect to privacy and security there may be an issue of unintentional exposure. That is, casting can unintentionally expose private or sensitive information seen in virtual reality. Intrusion risk includes unauthorized users potentially accessing and viewing the casted stream if not properly secured. Interactivity loss may include synchronization issues where interactive elements or third-person involvement might face synchronization issues. Device compatibility may arise because available solutions by META, GOOGLE (via CHROMECAST) and PICO (BYTEDANCE) are provided to be a 1:1 solution. One virtual reality headset can stream to one computing device (Laptop/Monitor etc.).

Additionally, conventional casting configurations may have complexity issues such as installation and setup. Setting up casting can be technically challenging, requiring proper network settings and compatible casting devices. Moreover, compatibility settings arise when not all devices or virtual reality platforms support casting, creating limitations based on available hardware and software versions.

### Configuration Examples

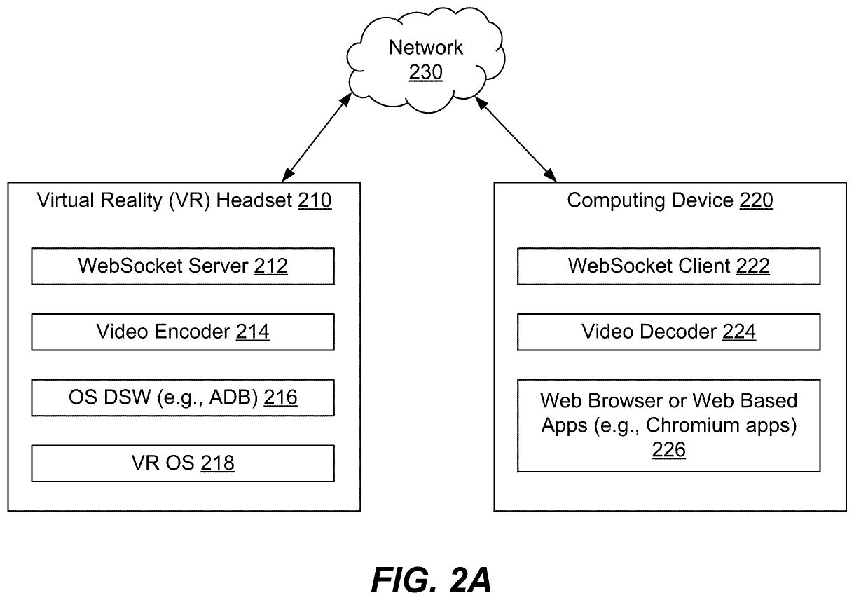

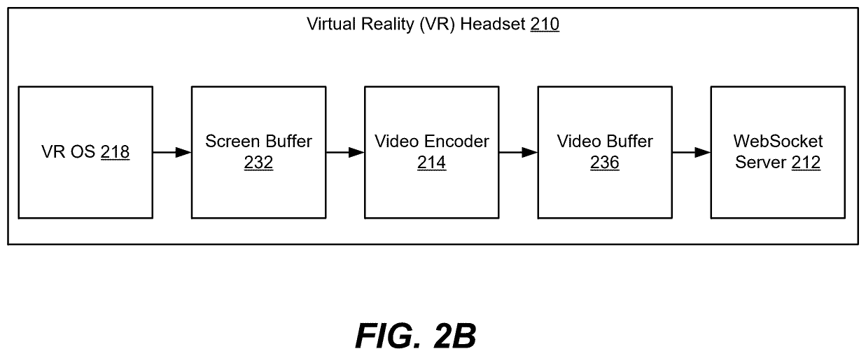

FIG. 2A is a block diagram of an example system environment for casting or streaming, in accordance with an embodiment. The environment includes a virtual reality headset 210, a computing device 220, and a network 230. The headset 210 and the computing device 220 are communicatively coupled through the network 230. Alternative embodiments may include more, fewer, or different components from those illustrated in FIG. 2A, and the functionality of each component may be divided between the components differently from the description below. Additionally, each component may perform their respective functionalities in response to a request from a human, or automatically without human intervention.

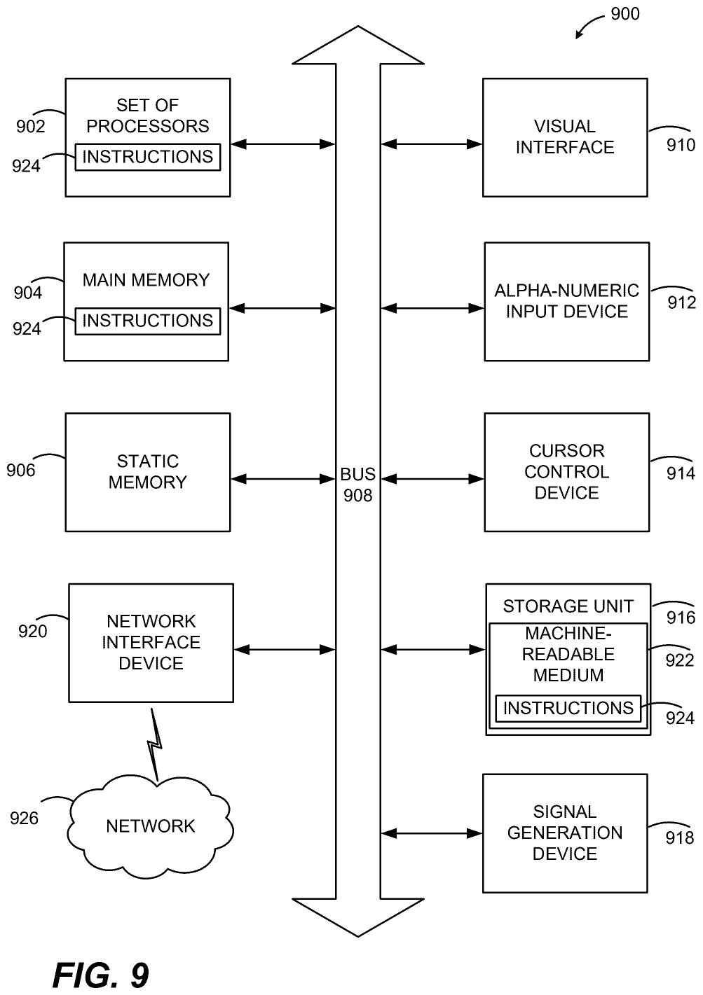

Although one virtual reality headset 210 and one computing device 220 are illustrated in FIG. 2A, a virtual reality headset may simultaneously cast or stream to multiple computing devices and multiple virtual reality headsets may simultaneously cast or stream to a computing device, as further described herein. As such, the environment of FIG. 2A may have more than one virtual reality headset and more than one computing device. Furthermore, a virtual reality headset (e.g., 210) and a computing device (e.g., 220) may have some or all components of the computing system described with respect to FIG. 9.

The network 230 may enable a collection of computing devices (e.g., 210, 220) to communicate via wired or wireless connections. The network 230 may include one or more local area networks (LANs) and/or one or more wide area networks (WANs). The network 230, as referred to herein, is an inclusive term that may refer to any or all of the standard layers used to describe a physical or virtual network, such as the physical layer, the data link layer, the network layer, the transport layer, the session layer, the presentation layer, and the application layer. The network 230 may include physical media for communicating data from one computing device to another computing device, such as multiprotocol label switching (MPLS) lines, fiber optic cables, cellular connections (e.g., 3G, 4G, or 5G spectra), or satellites. The network 230 also may use networking protocols, such as TCP/IP, HTTP, SSH, SMS, or FTP, to transmit data between computing devices. In some embodiments, the network 230 may include Bluetooth or near-field communication (NFC) technologies or protocols for local communications between computing devices. The network 230 may transmit encrypted or unencrypted data.

The virtual reality headset 210 is a wearable device that allows users to experience immersive, computer-generated environments e.g., as if they were physically present in them. It typically includes a head-mounted display with one or more screens (also “displays”) that show 3D visuals, sensors that track the user's head movements, and speakers for sound. By combining these elements, the headset 210 creates a sense of presence, letting users interact with virtual worlds for gaming, training, education, or other applications. The device may project images to each eye to simulate depth, while tracking movements to adjust the visuals in real time, creating a potentially seamless and lifelike experience.

A virtual reality headset (e.g., 210) may also include components that enable it to cast or stream (e.g., livestream) images, video, or audio data (or any combination thereof) to one or more computing devices. In the example of FIG. 2A, the virtual reality headset 210 includes a WebSocket server 212, a video encoder (e.g., H.264) 214, a (e.g., native) operating system debug software (OS DSW) 216 (e.g., ANDROID debug bridge (ADB) for ANDROID OS devices), and a virtual reality operating system (VR OS) 218 (e.g., ANDROID OS)). However, in other embodiments, the computing device 220 may include additional, fewer, or different components to cast or stream data. Although the example virtual reality headset 210 in FIG. 2A may be referred to as an ANDROID device and may include several ANDROID specific components, a virtual reality headset is not limited to being an ANDROID device or limited to ANDROID specific components but may extend to other operating system environments. The ANDROID device here is used by way of example for ease of discussion.

The computing device 220 can be a personal or mobile computing device, such as a smartphone, a tablet, a laptop computer, or a desktop computer. The computing device 220 may also be a server or component of a cloud provider. In some embodiments, the computing device 220 executes a client application that uses an application programming interface (API) to communicate with other devices, such as the virtual reality headset or another computing device. The computing device 220 may be referred to as a client device. In the example of FIG. 2A, the computing device 220 includes a WebSocket client 222, a video decoder (e.g., H.264) 224, and a web browser (e.g., a CHROMIUM based browser) or web based apps 226. However, in other embodiments, the computing device 220 may include additional, fewer, or different components.

A WebSocket is a protocol to provide full-duplex communication channels over a single TCP connection and is designed to facilitate real-time interactions between clients (e.g., the WebSocket client 222) and servers (e.g., the WebSocket server 212). Introduced as part of HTML5 and described by the RFC 6455 specification, WebSockets allow for significant performance improvements in scenarios where persistent, low-latency communication is desired. The WebSocket server 212 is an application listening on one or more ports of a TCP server that follows a specific protocol. The WebSocket client 222 uses a WebSocket API to communicate with WebSocket servers through the WebSocket protocol. Among other advantages, the use of a WebSocket in a virtual reality headset enables an encoded stream to be broadcast to many computing devices, dynamically routed, and replayed or stored in cloud APIs. For ease of discussion, the examples herein are in the context of WebSockets but the principles may apply to any computer communications protocol that provides a bidirectional communication channel over a single transmission control protocol connection.

The video encoder 214/decoder 224 in FIG. 2A may use, for example, any of the following standards: H.264 (Advanced Video Coding (AVC)), H.265 (High Efficiency Video Coding (HEVC)) or AV1 (AOMedia Video 1). H.264 is a video compression standard for recording, compressing, and distributing video content. H.264 is standardized by the International Telecommunication Union (ITU) and International Organization for Standardization/International Electrotechnical Commission (ISO/IEC). H.264 can provide efficient compression capabilities and high video quality. H.265 is a video compression standard designed to substantially improved encoding efficiency compared to its predecessor, H.264/AVC (Advanced Video Coding). Jointly developed by the ITU-T Video Coding Experts Group (VCEG) and the ISO/IEC Moving Picture Experts Group (MPEG), H.265 aims to reduce the bit rate used for video transmission and storage without compromising video quality. AOMedia Video 1 is an open, royalty-free video codec developed by the Alliance for Open Media (AOMedia), aiming to succeed VP9 and compete with other codecs such as H.265/HEVC.

Designed for efficient video compression while maintaining high visual quality, AV1 is improved (e.g., optimal) for internet video streaming and other high-demand applications.

As noted earlier, for ease of discussion the operating system debug software 216 will be described in the context of the ANDROID debug bridge. The ANDROID Debug Bridge (ADB) is a versatile command-line tool that allows developers to communicate with an ANDROID device, providing a bridge for debugging and other interactions between a computer and the ANDROID operating system. It is part of the ANDROID SDK (Software Development Kit).

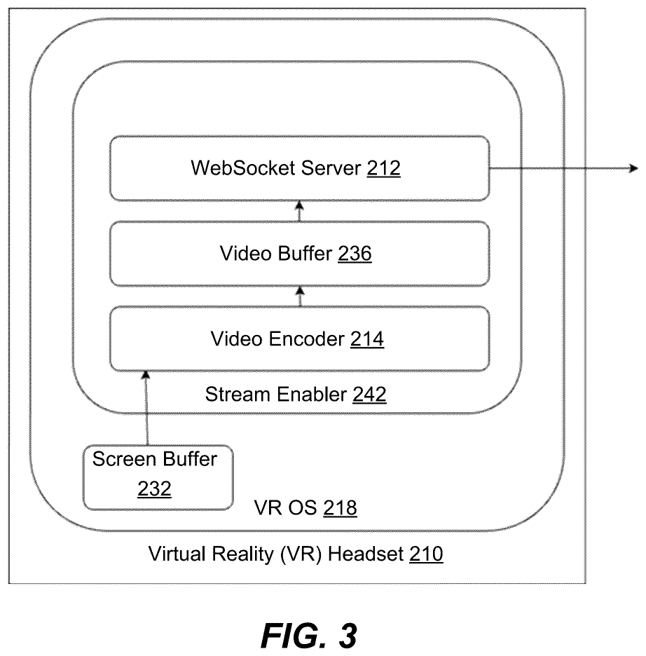

FIG. 2B is a flowchart illustrating an example casting or streaming processing flow on a virtual reality headset (e.g., 210), in accordance with an embodiment. The processing flow includes a VR OS 218 (operating system with VR support) a screen buffer 232, a video encoder 214, a video buffer 236, and a WebSocket server 212. In some embodiments, the process in FIG. 2B is enabled by a stream enabler, which is further described with respect to FIG. 3. The screen buffer 232 may be referred to as a frame buffer. The screen buffer 232 may be a memory area that holds the current visual contents that are to be displayed on the screen (or are being displayed on the screen or were displayed on the screen).

In the casting or streaming process flow, image data may flow sequentially from the virtual reality operating system 218 to the screen buffer 232, from the screen buffer 232 to the video encoder 214, from the video encoder 214 to the video buffer 236, and from the video buffer 236 to the WebSocket server 212 for transmission.

The virtual reality operating system 218 is configured to render image frames representing a virtual environment (e.g., based on application logic and user input). The rendered image frames are stored in the screen buffer 232, which temporarily retains frame data in memory. Frames in the screen buffer 232 are sent to display hardware for rendering on a display of the virtual reality headset 210 (not illustrated in FIG. 2B). Frames in the screen buffer 232 are also sent to the video encoder 214, which compresses the data into an encoded video format that reduces data size (e.g., while maintaining visual quality). The encoded video data is stored in a video buffer 236, which temporarily holds the compressed video stream, for example, to accommodate differences in the processing rates of preceding and subsequent components in the process flow. The video buffer 236 outputs the encoded video data to the WebSocket server 212, which packages and transmits the data over a WebSocket connection to the computing device 220.

To avoid flickering and tearing when displaying image data to the user, the virtual reality headset 210 may use double buffering. This involves using two buffers: one for the current display (front buffer) and one for the next frame being drawn (back buffer). When the back buffer is ready, it is swapped with the front buffer (thus, in these embodiments, the screen buffer of FIG. 2B may include both the front buffer and the back buffer). The virtual reality headset 210 also may utilize hardware acceleration to render graphics. For example, a GPU (Graphics Processing Unit) assists in the process of drawing to the screen buffer, leading to more efficient rendering and better performance especially for animations and complex graphics.

In some embodiments, in the context of application development, views and drawing mechanisms interact with the screen buffer through Surface and Canvas classes. Surface represents a drawing surface, and Canvas provides the API for drawing operations. In some embodiments, the operating system may use one or more layers (such as the status bar, application windows, and navigation bar), which are composited together in the screen buffer before being sent to the display hardware. For an example ANDROID device, this may be managed by a system service called SurfaceFlinger. In some embodiments, a buffer queue may manage the communication between a producer device (e.g., including the application or system drawing the content) and a consumer (or client) device (e.g., SurfaceFlinger). An ANDROID device may use a BufferQueue system. This may allow for the decoupling of the producer device and consumer device, enabling asynchronous and efficient rendering. In lower-level operations, such as for custom hardware or native applications, developers might interact directly with the frame buffer. This is less common in regular application development, where higher-level abstractions are generally used.

As previously mentioned, the WebSocket protocol allows bi-directional communication, including control. For example, a computing device may send (e.g., via JavaScript object notation (JSON)) commands (e.g., touch or gestures) to one or more streaming virtual reality headsets. This may be useful for remote guidance, teacher-student training, or collaborative virtual reality experiences.

FIG. 3 is a block diagram of a virtual reality headset (e.g., 210) with a stream enabler 242, according to one or more embodiments. The stream enabler 242 enables capturing, encoding, and casting or streaming of data (e.g., video) from the screen buffer 232. For example, the stream enabler 242 facilitates one or more steps in the process flow of FIG. 2B. The stream enabler 242 may be an application running as a (e.g., background) service by the operating system (the VR OS 218). The stream enabler 242 may be responsible for enabling operating system (OS) flags to provide screen buffer access.

As described with respect to FIG. 2B, the screen buffer 232 is a memory where graphical data is stored before it is sent to the display. For example, the screen buffer 232 holds the current state of each pixel to be displayed on the screen, thus helping facilitate the smooth rendering of images, animations, and other graphical content on the virtual reality headset. The screen buffer 232 is constantly updated to reflect changes in the graphical output, helping ensure that the display shows the most recent content. The video encoder 214 may read raw bytes from the screen buffer 232 (e.g., via a MediaProjection API) and convert them into a (e.g., widely-standard) video encoding, such as H.264/H.265. Similarly, a video decoder (e.g., on a receiving client device, such as 220), is configured to receive the encoded data after it has been received from a WebSocket client 222 and decode the data using the same standard as the video encoder 214. The WebSocket Server 212 is responsible for streaming the encoded video data out of the virtual reality headset 210 to one or more receiving computing devices (e.g., 220). For example, the WebSocket server 212 can be used to live stream video content to the internet (e.g., YOUTUBE or TWITCH) or in a local area network (LAN) to a computing device (e.g., with an appropriate application or web browser). Thus, the virtual reality headset 210 can wirelessly stream virtual reality headset 210 content without plugin-via-USB to a personal computer (PC) in LAN mode or to directly stream virtual reality headset 210 content to cloud solutions (YOUTUBE, TWITCH, DISCORD, etc.).

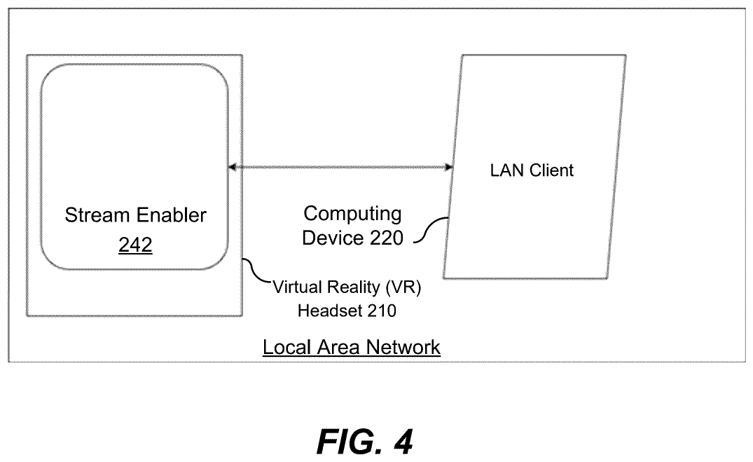

FIG. 4 is a block diagram illustrating an example local area network (e.g., 230) implementation, according to one or more embodiments. More specifically, a virtual reality headset (e.g., 210) and a computing device (e.g., 220) are part of the same local area network and the virtual reality headset 210 streams data (e.g., video) to the computing device through the local area network (without the internet). The computing device includes a LAN (local area network) client, such as a browser or native application. As previously indicated, the stream enabler enables opening a socket connection that any native client (e.g., applications for WINDOWS, LINUX, MACOS, IPHONE OS, ANDROID or Web Browser can connect to and stream the content.

Furthermore, for streaming in local area networks, the video stream packet structure may be a raw byte stream of encoded (e.g., via H.264 or H.265) network abstraction layer (NAL) units. There may be no framing or headers added to the video. Thus, the decoder may parse the NAL units directly. Among other advantages, this reduces latency overhead and allows streaming to begin quickly (e.g., immediately) after the encoder starts on the device.

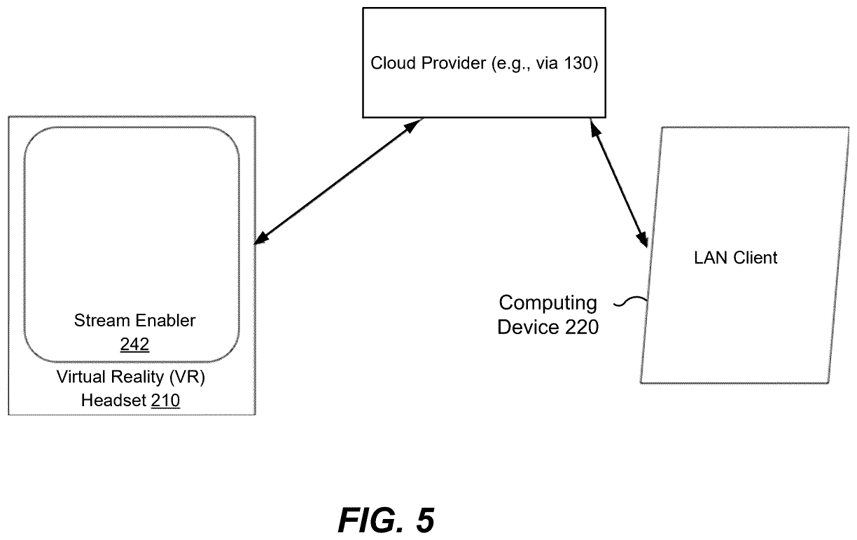

FIG. 5 is a block diagram illustrating an example cloud mode implementation for streaming, according to one or more embodiments. The example of FIG. 5 includes a virtual reality headset (e.g., 210) with a stream enabler 242, a computing device (e.g., 220) with a LAN (local area network) client (such as a browser or native application (e.g., applications for WINDOWS, LINUX, MAC, IPHONE, or ANDROID), and a cloud provider. The virtual reality headset 210 and the computing device 220 each communicate with the cloud provider through a network (e.g., 230), which is omitted from FIG. 5 for simplicity. In some embodiments, the computing device and the cloud provider are on the same local area network and communicate with each other over the local area network, and while the virtual reality device communicates with the cloud provider over the internet. The stream enabler connects and streams (e.g., live) content (e.g., video) of the virtual reality headset viewport to the cloud provider (e.g., in-house, YOUTUBE LIVE, or TWITCH). These streams can be cloud recorded and/or viewed live by the computing device 220.

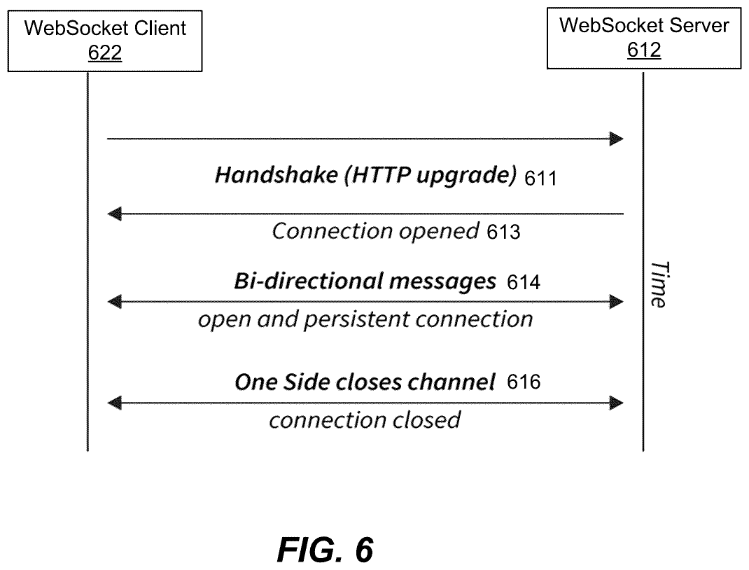

FIG. 6 illustrates an example of a WebSocket process flow to stream full duplex mode in accordance with an embodiment. More specifically, FIG. 6 illustrates an example sequence of operations for establishing, using, and closing a WebSocket communication channel between a WebSocket client 622 (e.g., 222) and a WebSocket server 612 (e.g., 212). Initially, the client and server perform a handshake 611, which is an HTTP upgrade request and response sequence that transitions the connection from the HTTP protocol to the WebSocket protocol, enabling full-duplex communication. Upon successful completion of the handshake, the connection is opened 613, meaning that both endpoints can begin data exchange over the upgraded channel. Once open, bi-directional messages are transmitted 614 between the client and server, allowing simultaneous sending and receiving of data over a single persistent connection without the need to repeatedly establish new connections. This state is maintained until one endpoint initiates closure, at which point a channel close signal is sent 616 to terminate communication. Following this action, the connection is closed, and no further data is exchanged between the client and the server.

Utilizing a WebSocket to stream video (e.g., encoded via H.264 or H.265) enables casting or streaming, via multiple sockets in a full duplex mode, to many different computing devices. Furthermore, due to W3C standards, and modern browsers, the video can be cast or streamed directly to, for example, a CHROME/CHROMIUM browser or an equivalent via multiple sockets in a full duplex mode by adjusting magic bytes (first few bytes of a file to recognize that file) and creating a bilateral handshake.

A WebSocket server (e.g. 212 or 612) can be bi-directional and may be configured to have bytes or packets of data continuously streamed. In some embodiments, audio and video of a virtual reality headset is streamed continuously as bytes of array in the video encoded format. This data can be transmitted to multiple clients e.g., within the same network.

In an example embodiment, if there is a risk of overloading the current hardware limitations, stream one virtual reality headset bytes out of the virtual reality headset. However, due to modern laptops and Chromebooks having enough specs to stream multiple content using the H.264 or H.265 standards, a single client device (Laptop) can stream multiple videos from virtual reality headset as sources (server) within the same network.

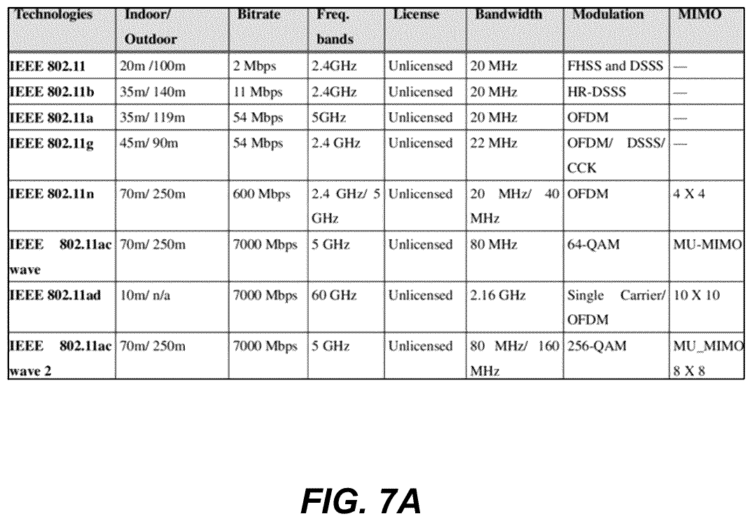

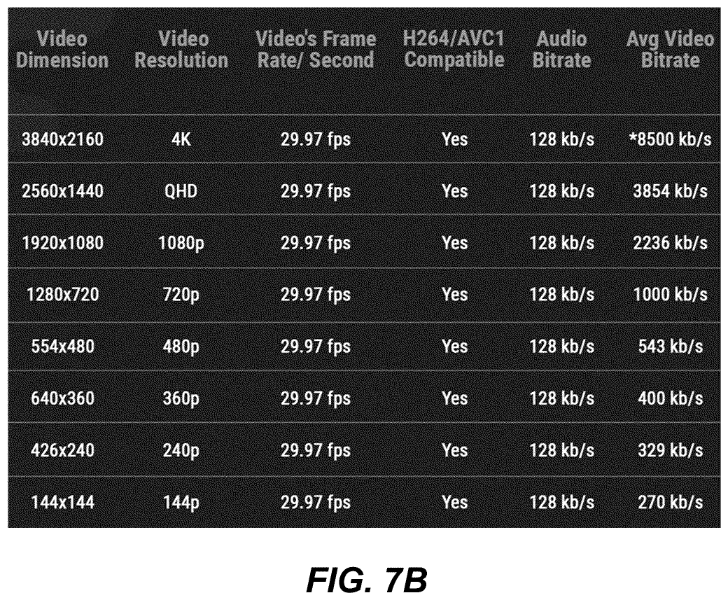

Among other advantages, casting or streaming within a local area network (LAN) eliminates latency from ISPs (internet service providers). Example throughputs for LANs are 600 Mbps to 6 Gbps, as shown in FIG. 7A. For example, for a 1080p video, the audio and video bitrate is 2236 kbps 128 kbps=2.3 Mbps, according to the chart in FIG. 7B. Thus, for an example infrastructure with a network of 802.11n, and a throughput of 600 Mbps, this is about 260 continuous video streams.

For embodiments with internet access and encoding standards in H.264 and H.265, this may allow for live streaming events via YouTube APIs and Twitch APIs. Thus, among other advantages, multiple virtual reality headsets can stream simultaneously to these video providing servers and can be live streamed (with certain latency) and can also be provisioned for cloud storage (in accordance with user privacy settings and privacy laws).

Some embodiment also includes increased security. For example, LAN embodiments may be a peer to peer (p2p) connections, where the device origin is the virtual reality headset and the end device is the computing device. Further, encoding a video (e.g., via H.264 or H.265) increases security as the encoding hinders or prevents bad actors from accessing the video even if a bad actor is able to intercept the video.

Thus, some embodiments structure a service through a virtual reality application on a virtual reality headset. Many pixels (e.g., every pixel) rendered on the virtual reality headset are captured into a format, e.g., H.264 or H.265, to stream. The formatted data is stored in a buffer and enables streaming. This is unlike screen record of conventional systems such as stream casting. This removes the need for a manufacturer of a virtual reality device to enable stream casting application programming interfaces (APIs). Furthermore, in some embodiments, this helps enable a virtual reality headset to be communicatively coupled (e.g., stream video) to more than one computing device.

### Example Methods of Casting or Streaming

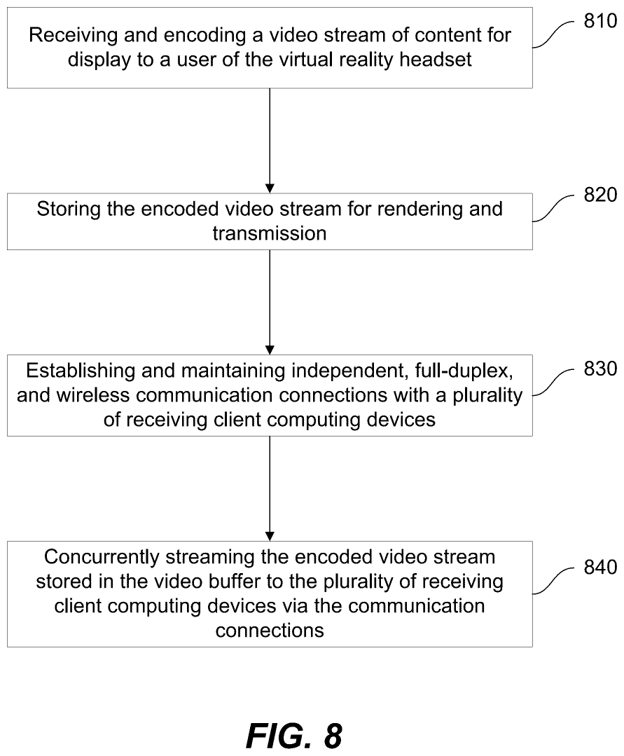

FIG. 8 is a flowchart of an example method for casting or streaming, according to one or more embodiments. In the example of FIG. 8, steps of the method are performed by a virtual reality headset 210 with a video encoder 214, video buffer 236, and WebSocket server 212, however one or more steps of the method may be performed by another device (or multiple devices). Other embodiments may include more, fewer, or different steps from those illustrated in FIG. 8, and the steps may be performed in a different order from that illustrated in FIG. 8. Additionally, each of these steps may be performed automatically without human intervention.

At step 810, the video encoder 214 receives and encodes a video stream of content for display to a user of the virtual reality headset (e.g., via a screen or projector of the headset).

At step 820, the video buffer 236 stores the encoded video stream for rendering and transmission.

At step 830, the WebSocket server 212 establishes and (e.g., simultaneously) maintains independent, full-duplex (e.g., bi-directional), and wireless communication connections with (e.g., WebSocket clients (e.g., 222) of) a plurality of receiving client computing devices (e.g., 220) (e.g., external to the virtual reality headset 210).

At step 840, the WebSocket server 212 concurrently streams the encoded video stream stored in the video buffer 236 to the plurality of receiving client computing devices via the communication connections (e.g., thereby enabling real-time delivery of video content rendered by the virtual reality headset 210 over a network to multiple client computing devices(e.g., 220)).

In some embodiments, streaming the encoded video data to the plurality of receiving client computing devices includes the WebSocket server 212 transmitting packets of the encoded video stream stored in the video buffer as WebSocket messages to the (e.g., WebSocket clients (e.g., 222) of the) plurality of receiving client computing devices (e.g., in parallel).

In some embodiments, the method further includes the WebSocket server 212 receiving, via the communication connections, independent requests from the plurality of (e.g., WebSocket clients (e.g., 222) of the) receiving client computing devices.

In some embodiments, the WebSocket server 212 does not support adaptive streaming. In these embodiments, at least one of the receiving client computing devices may be a cloud server configured to perform adaptive streaming of the encoded video stream to other client computing devices.

In some embodiments, the virtual reality headset 210 with its WebSocket server 212 and the plurality of receiving client computing devices are nodes on the same local area network, e.g., 230, and the WebSocket server 212 establishes and maintains the wireless communication connections over the local area network without internet connectivity (e.g., the virtual reality headset is not connected to the internet or the WebSocket server 212 establishes and maintains the wireless communication connections without connecting to the internet or communicating via the internet).

In some embodiments, the method further includes WebSocket clients 222 of the receiving client computing devices receiving, via corresponding communication connections, the encoded video stream from the WebSocket server 212 of the VR headset 210.

Other aspects include components, devices, systems, improvements, methods, processes, applications, computer readable mediums, and other technologies related to any of the above.

### Example Virtual Reality Headsets

In some embodiments, a virtual reality headset 210 includes: a video encoder 214 configured to receive and encode a video stream of content for display to a user of the virtual reality headset; a video buffer configured to store the encoded video stream for rendering and transmission; and a WebSocket server 212 coupled to the video buffer 236 and configured to: establish and (e.g., simultaneously) maintain independent, full-duplex (e.g., bi-directional), and wireless communication connections with a plurality of receiving client computing devices 220 (e.g., external to the virtual reality headset); and stream the encoded video stream stored in the video buffer 236 concurrently to the plurality of receiving client computing devices 220 via the communication connections (e.g., thereby enabling real-time delivery of video content rendered by the virtual reality headset over a network to multiple clients).

In some embodiments, to stream the encoded video data to the plurality of receiving client computing devices 220, the WebSocket server 212 is configured to transmit packets of the encoded video stream stored in the video buffer as WebSocket messages to the plurality of receiving client computing devices 220 (e.g., in parallel).

In some embodiments, the WebSocket server 212 of the VR headset 210 is further configured to receive independent requests via the communication connections from the plurality of receiving client computing devices 220.

In some embodiments, the WebSocket server 212 of the VR headset 210 may not support adaptive streaming. In some embodiments, at least one of the receiving client computing devices 220 is a cloud server configured to perform adaptive streaming of the encoded video stream to other client computing devices 220.

In some embodiments, the VR headset 210 with WebSocket server 212 and the plurality of receiving client computing devices 220 (e.g., each with WebSocket clients 222) are nodes on the same local area network, e.g., 230, and the WebSocket server 212 is configured to establish and maintain the wireless communication connections over the local area network without internet connectivity.

In some embodiments, the receiving client computing devices have WebSocket clients 222 configured to receive, via a corresponding communication connection, the encoded video stream from the WebSocket server 212.

Some embodiments relate to a system including: a plurality of virtual reality headsets (e.g., 210), each virtual reality headset 210 including: a video encoder 214 configured to receive and encode a video stream of content for display to a user of the virtual reality headset; a video buffer 236 configured to store the encoded video stream for rendering and transmission; and a WebSocket server 212 coupled to the video buffer 236, wherein the WebSocket servers 212 of the plurality of virtual reality headsets are configured to concurrently stream encoded video streams to a single client computing device 220.

Some embodiments relate to a client computing device 220 including: a WebSocket client 222 configured to: establish and maintain, via a WebSocket API, independent, full-duplex, and wireless communication connections with a plurality of WebSocket servers 212 of virtual reality headsets (e.g., 210); and concurrently receive, via the communication connections, encoded video streams of content for display to users of the virtual reality headsets from the plurality of WebSocket servers 212 of virtual reality headsets; a video decoder 224 configured to decode encoded video streams received by the WebSocket client 222; and a display configured to display video streams decoded by the video decoder 224.

Other aspects include components, devices, systems, improvements, methods, processes, applications, computer readable mediums, and other technologies related to any of the above.

### Computing Machine Architecture

FIG. 9 is a block diagram illustrating one example embodiment of components of an example machine able to read instructions from a machine-readable medium and execute them in a set of one or more processors. Specifically, FIG. 9 shows a diagrammatic representation of a machine in the example form of a computer system 900 within which program code (e.g., software) for causing the machine to perform any one or more of the methodologies discussed herein may be executed. For example, any of the virtual reality headsets (e.g., 210) or computing devices (e.g., 220) previously described may be implemented by one or more components of the computer system 900. The program code may be comprised of instructions 924 executable by a set of one or more processors 902 (if there are multiple processors, they may work individually or collectively). In alternative embodiments, the machine operates as a standalone device or may be coupled (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes a set of one or more processors 902 (e.g., one or more central processing units (CPUs), one or more graphics processing unit (GPUs), one or more digital signal processors (DSPs), one or more application specific integrated circuits (ASICs), one or more radio-frequency integrated circuits (RFICs), one or more field programmable gate arrays (FPGAs), or some combination thereof), a main memory 904, and a static memory 906, which are configured to communicate with each other via a bus 908. The computer system 900 may further include visual display interface 910 (example display interfaces 910 include 210 and 230). The visual interface may include a software driver that enables (or provide) user interfaces to render on a screen either directly or indirectly. The visual interface 910 may interface with a touch enabled screen. The computer system 900 may also include input devices 912 (e.g., a keyboard a mouse), a storage unit 916, a signal generation device 918 (e.g., a microphone and/or speaker), a cursor control device 914, and a network interface device 920 configured to interface with a network 926, which also are configured to communicate via the bus 908.

The storage unit 916 includes a (e.g., non-transitory) machine-readable medium 922 (e.g., magnetic disk or solid-state memory) on which is stored instructions 924 (e.g., software) embodying any one or more of the methodologies or functions described herein. The instructions 924 (e.g., software) may also reside, completely or at least partially, within the main memory 904 or within the processor 902 (e.g., within a processor's cache memory) during execution.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, any reference to “one embodiment” or “an embodiment” means that a particular element, feature, or structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” or “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for enabling bidirectional communication between multiple VR (or AR) headsets through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A virtual reality headset comprising:
a video encoder configured to receive and encode a video stream of content for display to a user of the virtual reality headset;
a video buffer configured to store the encoded video stream for rendering and transmission; and
a WebSocket server coupled to the video buffer and configured to:
establish and maintain independent, full-duplex, and wireless communication connections with a plurality of receiving client computing devices; and
stream the encoded video stream stored in the video buffer concurrently to the plurality of receiving client computing devices via the communication connections.

2. The virtual reality headset of claim 1, wherein to stream the encoded video data to the plurality of receiving client computing devices, the WebSocket server is configured to transmit packets of the encoded video stream stored in the video buffer as WebSocket messages to the plurality of receiving client computing devices.

3. The virtual reality headset of claim 1, wherein the WebSocket server is further configured to receive independent requests via the communication connections from the plurality of receiving client computing devices.

4. The virtual reality headset of claim 1, wherein the WebSocket server does not support adaptive streaming.

5. The virtual reality headset of claim 4, wherein at least one of the receiving client computing devices is a cloud server configured to perform adaptive streaming of the encoded video stream to other client computing devices.

6. The virtual reality headset of claim 1, wherein the WebSocket server and the plurality of receiving client computing devices are nodes on the same local area network and the WebSocket server is configured to establish and maintain the wireless communication connections over the local area network without internet connectivity.

7. The virtual reality headset of claim 1, wherein the receiving client computing devices have WebSocket clients configured to receive, via a corresponding communication connection, the encoded video stream from the WebSocket server.

8. A method comprising:
receiving and encoding, by a video encoder of a virtual reality headset, a video stream of content for display to a user of the virtual reality headset;
storing, by a video buffer of the virtual reality headset, the encoded video stream for rendering and transmission;
establishing and maintaining, by a WebSocket server of the virtual reality headset, independent, full-duplex, and wireless communication connections with a plurality of receiving client computing devices; and
concurrently streaming, by the WebSocket Server of the virtual reality headset, the encoded video stream stored in the video buffer to the plurality of receiving client computing devices via the communication connections.

9. The method of claim 8, wherein streaming the encoded video data to the plurality of receiving client computing devices comprises the WebSocket server transmitting packets of the encoded video stream stored in the video buffer as WebSocket messages to the plurality of receiving client computing devices.

10. The method of claim 8, further comprising the WebSocket receiving, via the communication connections, independent requests from the plurality of receiving client computing devices.

11. The method of claim 8, wherein the WebSocket server does not support adaptive streaming.

12. The method of claim 11, wherein at least one of the receiving client computing devices is a cloud server configured to perform adaptive streaming of the encoded video stream to other client computing devices.

13. The method of claim 8, wherein:
the WebSocket server and the plurality of receiving client computing devices are nodes on the same local area network; and
the WebSocket server establishes and maintains the wireless communication connections over the local area network without internet connectivity.

14. The method of claim 8, further comprising:
WebSocket clients of the receiving client computing devices receiving, via corresponding communication connections, the encoded video stream from the WebSocket server.

15. One or more non-transitory computer-readable storage mediums storing instructions that, when executed by a virtual reality headset, cause the virtual reality headset to:
receive and encode, by a video encoder of the virtual reality headset, a video stream of content for display to a user of the virtual reality headset;
store, by a video buffer of the virtual reality headset, the encoded video stream for rendering and transmission;
establish and maintain, by a WebSocket server of the virtual reality headset, independent, full-duplex, and wireless communication connections with a plurality of receiving client computing devices; and
concurrently stream, by the WebSocket Server of the virtual reality headset, the encoded video stream stored in the video buffer to the plurality of receiving client computing devices via the communication connections.

16. The one or more non-transitory computer-readable storage mediums of claim 15, wherein to stream the encoded video data to the plurality of receiving client computing devices, the instructions cause the virtual reality headset to transmit, by the WebSocket server, packets of the encoded video stream stored in the video buffer as WebSocket messages to the plurality of receiving client computing devices.

17. The one or more non-transitory computer-readable storage mediums of claim 15, wherein the instructions further cause the virtual reality headset to receive, by the WebSocket via the communication connections, independent requests from the plurality of receiving client computing devices.

18. The one or more non-transitory computer-readable storage mediums of claim 15, wherein the WebSocket server does not support adaptive streaming.

19. The one or more non-transitory computer-readable storage mediums of claim 18, wherein at least one of the receiving client computing devices is a cloud server configured to perform adaptive streaming of the encoded video stream to other client computing devices.

20. The one or more non-transitory computer-readable storage mediums of claim 15, wherein:
the WebSocket server and the plurality of receiving client computing devices are nodes on the same local area network; and
the instructions cause the virtual reality headset to, by the WebSocket, establish and maintain the wireless communication connections over the local area network without internet connectivity.
